(19) United States
(12) Patent Application Publication
(10) Pub. No.: US 2011/0288876 A1
(43) Pub. Date: Nov. 24, 2011

(54) SYSTEM AND METHOD TO ASSIST HEALTH ADVOCATE PROFESSIONALS AND EMPLOYERS

(75) Inventors: Michael Cardillo, Point Pleasant Beach, NJ (US); Daniel Messina, West Palm Beach, FL (US); Kelly Johnston, Harleysville, PA (US)

(73) Assignee: HEALTH ADVOCATE, Plymouth Meeting, PA (US)

(21) Appl. No.: 12/783,241

(22) Filed: May 19, 2010

(51) Int. Cl. G06Q 50/00; G06Q 10/00; G06F 3/048; G06Q 40/00

(52) U.S. Cl. 705/2; 715/764

(57) ABSTRACT

A computer-assisted method for assisting a health advocate professional in counseling employees of a plan sponsor comprising receiving health records of employees of a plan sponsor, analyzing data in the records, displaying the analyzed data for any selected employee in dashboard format, calculating any health improvement options for the selected employee, and displaying the health improvement options in the form of questions to be asked by a health advocate professional viewing the displayed dashboard, preferably arranged in categories under spotlight buttons, and a computer system adapted to carry out the method. The method and system can also provide in some embodiments summary medical benefits usage information to plan sponsors, including costs, health improvement options, return on investment.

### BACKGROUND

The present invention relates to a system, method, and device for assisting health advocate professionals and plan sponsors in managing employee health records, assisting employees in health management and improvement, and interpreting statistical information to the plan sponsors.

Plan sponsors who provide health benefits to their employees typically pay at least a share of the individual employees' insurance costs. For that reason alone, such plan sponsors are motivated to try to improve each employee's health, reduce health risks, and institute general health improvement programs. However, plan sponsors are not generally permitted to know health information on an individual employee level and so in order to counsel employees, third parties are sometimes retained. The third parties are not permitted to report individual employee health data to the plan sponsor, but they are permitted to report summary information, e.g., average usage of drugs, hospitals, doctors, and the like, as long as the individual employee's information can not be readily deduced from the summary information.

The third parties can include what is known in the trade as health advocate companies, and the people who have contact with employees will be referred to herein as health advocate professionals (“HAP”).

Traditionally the health advocate professionals often have access to individual employee information so that when an employee calls, the health advocate professional can obtain information from the employee and provide information to the employee which had been received from various sources, among which can be the plan sponsor, an insurance company, a hospital, pharmacy provider, or physician.

More recently the role of the health advocate professional has expanded insofar as plan sponsors desire the health advocate professional to take a role in advising on options to improve the health of individual employees rather than merely company-wide programs for that purpose.

It is an object of the present invention to provide means to assist the health advocate professional in assessing options for improvement of an individual employee's health situation.

It is also an object of the invention to enable provision of summary employee health information to plan sponsors, and to report on health improvement options on a summarized basis.

A further object is to enable reporting of return on a plan sponsor's investment in health improvement programs.

### SUMMARY OF THE INVENTION

These objects, and others which will become apparent from the following detailed description and drawings, are achieved by the present invention which comprises in one aspect a method for assisting a health advocate professional in counseling employees of a plan sponsor comprising receiving health records of employees of a plan sponsor, analyzing data in the records, displaying the analyzed data for any selected employee in dashboard format, calculating any health improvement options for the selected employee, and displaying the health improvement options in the form of questions to be asked by a health advocate professional viewing the displayed dashboard.

In another aspect, the invention comprises a computer system for assisting a health advocate professional in counseling employees of a plan sponsor comprising a module adapted to receive a plurality of data feeds relating to records of employees of a plan sponsor from sources comprising the plan sponsor's human resources management system, a health care provider, and health benefit vendors and store the records; a module adapted to display a selected record in dashboard format; and a module adapted to calculate any health improvement options in the form of questions to be asked by the health advocate professional viewing the displayed dashboard for the selected employee.

In another aspect, the invention comprises a computer-assisted method for managing employee health care-related costs and employee health care effectiveness of a plan sponsor having a population of employees comprising receiving a plurality of data feeds from sources comprising a plan sponsor human resources management system, health care providers, and an employee self-reporting computer system; calculating statistical information from the data; and generating a plan sponsor dashboard interface for presenting the statistical information relating to employee benefits, medical benefit usage by employees, risk factors, health insurance eligibility and usage, and contacts with a benefits provider.

In a preferred embodiment the method comprises, and the system enables, displaying spotlight buttons within the dashboard for disease management, lifestyle coaching, prescription compliance, and medical tests which, when clicked on or selected by the health advocate professional, automatically displays a question and a field for the health advocate professional to enter an answer, and record any answers in the record of the employee. The method can include displaying a set of categories in spotlight format and a customized question to be asked relating to one of the categories when the corresponding spotlight is selected. The spotlight can be selected by any means, for example by hovering the mouse pointer over the spotlight or simply clicking on the spotlight. Touch screen technology can also be used in this step.

The system in some embodiments will receive data from a human resource management system of the plan sponsor, from health care providers for employees of the plan sponsor, and from one or more health benefit vendors, and will update the records as the data is received.

A plan sponsor interface can be provided by the computer system wherein the interface displays in dashboard format summaries of medical benefit usage by employees, risk factors, health insurance eligibility and usage, and contacts with a benefits provider.

The health advocate professional dashboard will usually display data comprising an employee's name, medical plan, medical plan deductibles, amount of medical plan deductible met, medical plan co-pays, pharmacy plan, pharmacy plan deductibles, amount of pharmacy plan deductible met, pharmacy co-pays, smoking, weight, blood pressure, cholesterol, diabetes, asthma, and heart disease risks and program participation.

The plan sponsor dashboard interface can display one or more of employee statistics, return on investment factors, long term disability participant information, preventative care statistics, disease management statistics, wellness statistics, prescription statistics, medical benefits statistics, employee demographics, and productivity benchmarks.

### BRIEF DESCRIPTION OF THE DRAWINGS

FIGS. 1-8 are examples of a health advocate professional dashboard illustrating the spotlights and questions generated when one spotlight is selected.

FIGS. 9, 10, and 11 are examples of “client screens” of plan sponsor XYZ Company in presenting summaries of various aspects of employee health management.

### DETAILED DESCRIPTION

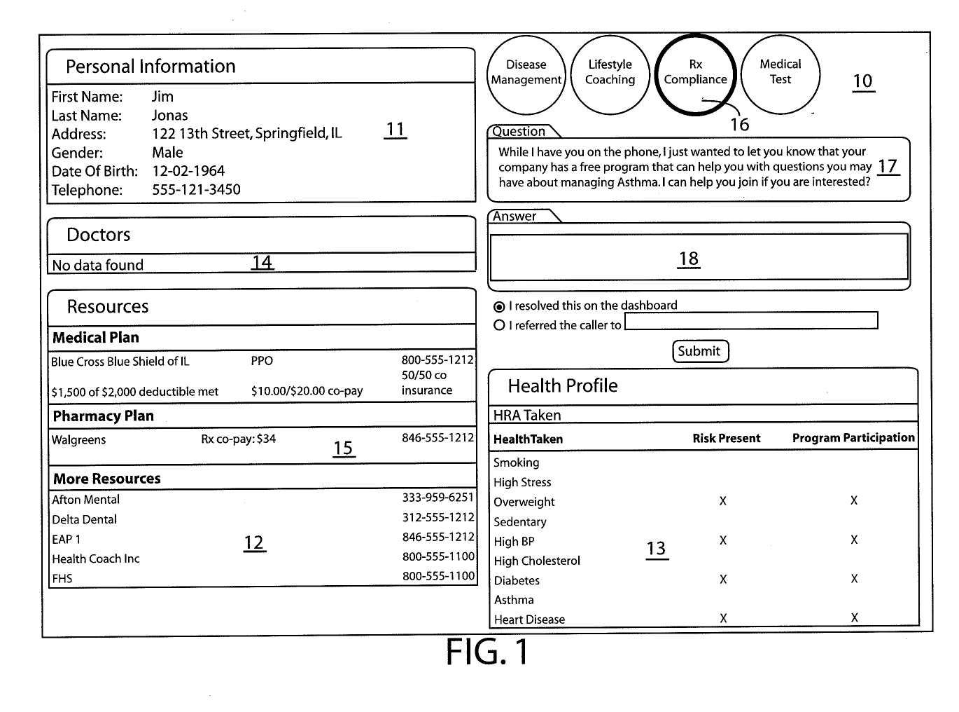

As illustrated in FIG. 1, the present invention provides a dashboard display for a health advocate professional to use when speaking over the telephone to an employee of a client plan sponsor wherein personal information 11 such as name, date of birth, and the like are displayed. Such information will be populated by plan sponsor data feeds. Also displayed are doctor information 14 which can be populated by insurance company feeds, for example, or by the employee him or herself to the health advocate professional. Other fields in the illustrated embodiment are pharmacy plan 15, more resources 12, and health profile 13 which comprise smoking status, weight, stress, blood pressure, and any of a wide variety of information.

In FIG. 1, spotlight section 10 the “Rx Compliance” spotlight has been selected by the health advocate professional which caused a customized question regarding an asthma program to populate the question field 17 and an answer space 18 below it for the professional to enter the employee's answer. Question 17 is to ask whether this employee is interested in an asthma program.

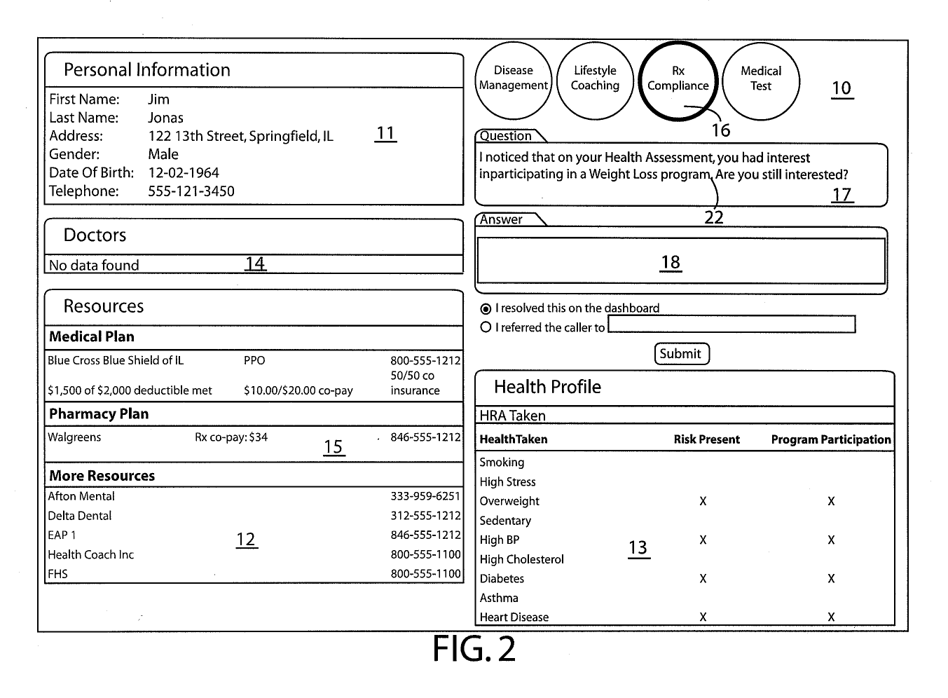

In FIG. 2, a second question 22 under Rx Compliance 16 is illustrated, this question being about the weight loss program.

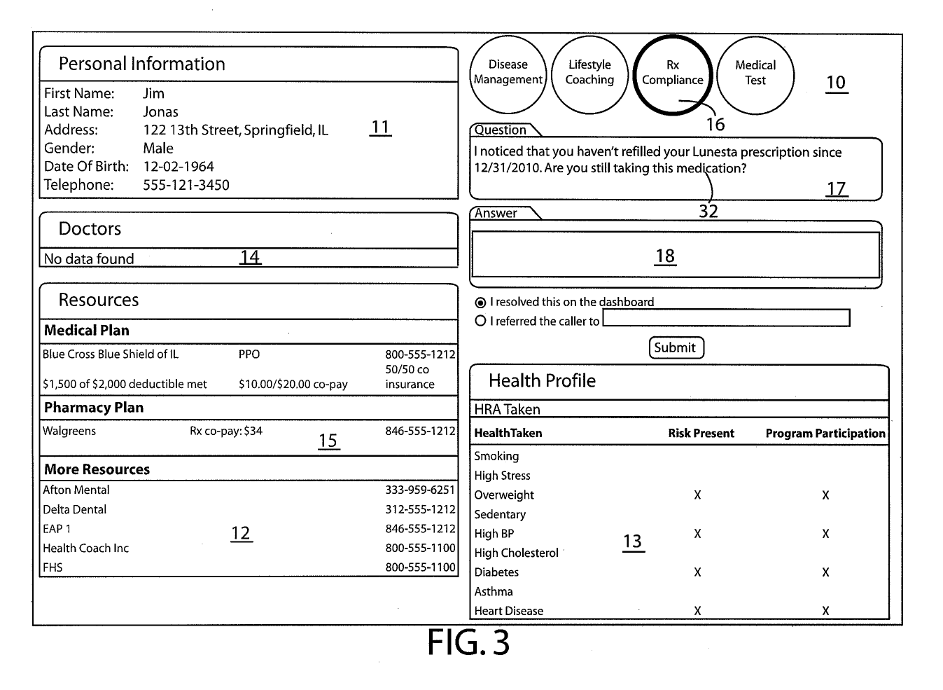

If FIG. 3, a third question 32 under spotlight “Rx Compliance” 16 populates the question field 32 with a question 32 about whether medication is being taken.

In some embodiments the spotlights vary, depending on the categories of questions selected by the system to be asked of the selected employee. For example, if there is no Rx Compliance question appropriate to the selected employee, no Rx Compliance spotlight will be displayed. In other embodiments, an Rx Compliance spotlight would be displayed for that selected employee's dashboard, but that spotlight would be shaded or otherwise indicated as non-selectable by the health advocate professional.

Each of FIGS. 1-3 are for a single employee and therefore have the same spotlights in the spotlight section designed to prompt the heath advocate professional to ask questions which are customized to the individual employee's health and life situation, for example “how about enrolling in the free smoking cessation course” or “ have you considered a weight reduction course,” as just a few of the many possibilities. All of the questions are based on relationships based on experience, for example the employee's height, weight, and age can be analyzed and recommendations generated in the form of questions.

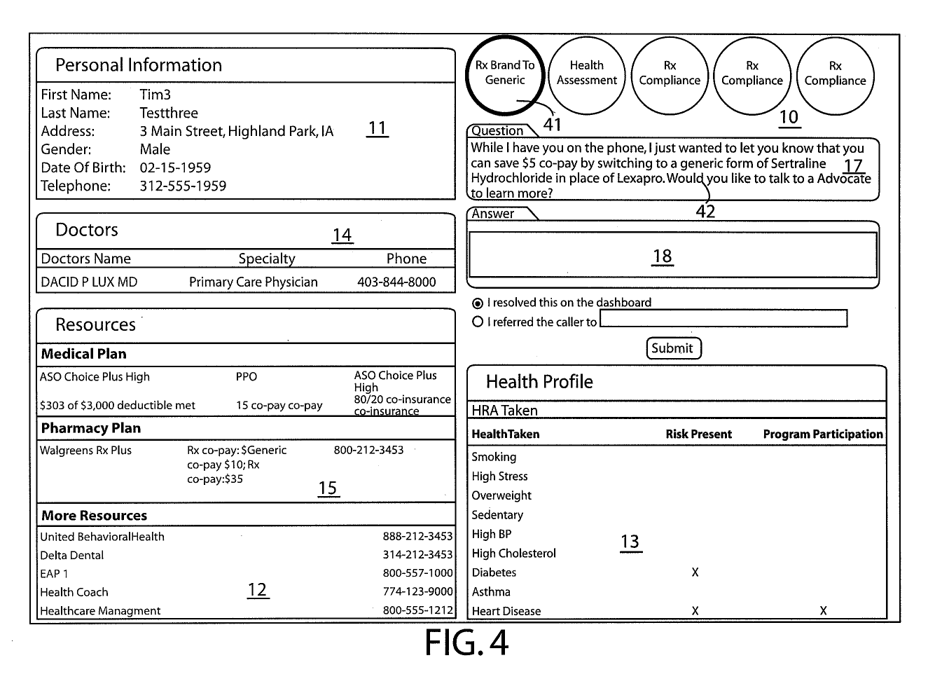

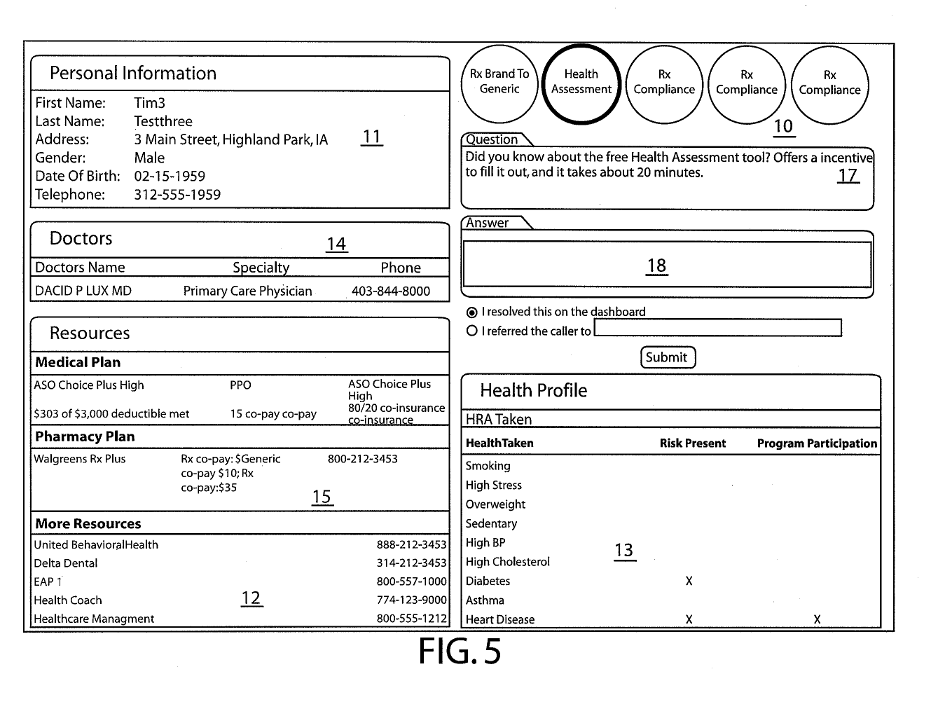

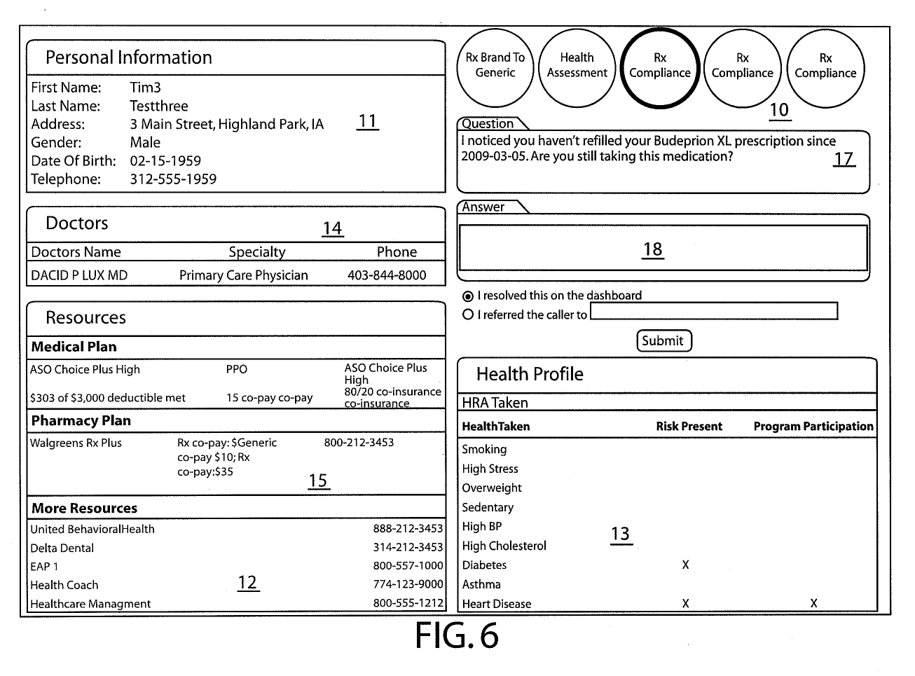

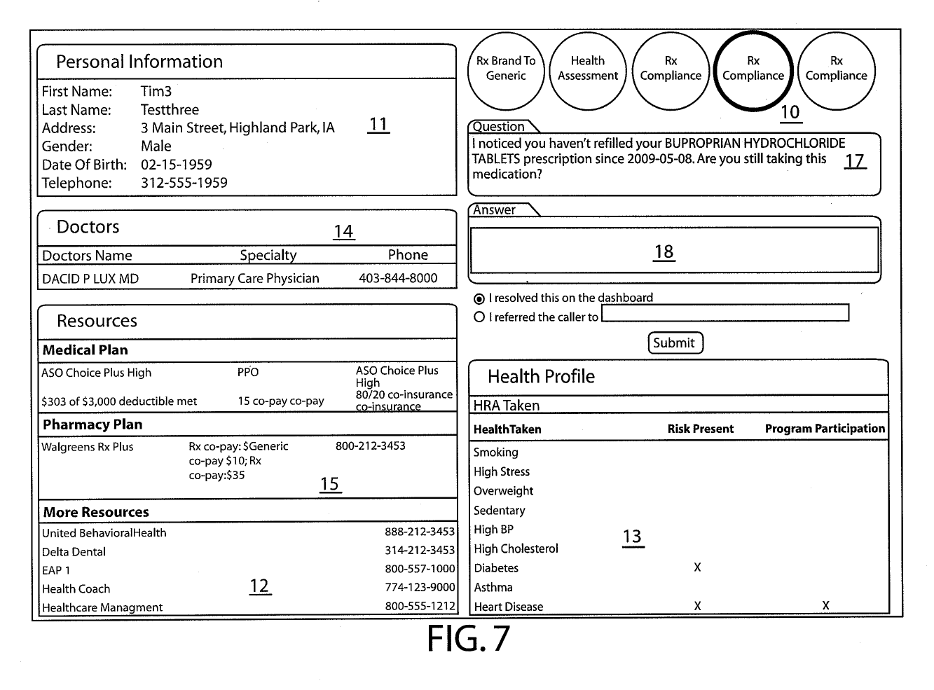

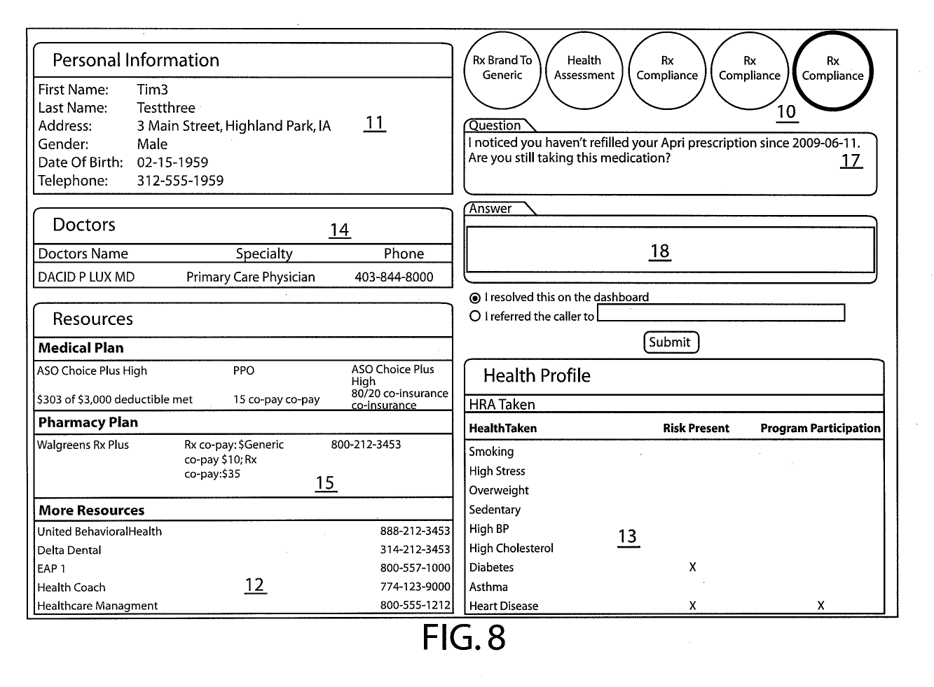

In the case of a different employee illustrated in FIGS. 4-8, the system automatically populates the spotlight section with a set of spotlights customized for that particular employee, in this instance Rx Brand to Generic, Health Assessment, Rx Compliance in three spotlights because the system found three separate questions under the Rx Compliance should be asked of this employee. In FIG. 4, the question is about a generic equivalent, in FIG. 5 it is about a Health Assessment tool, in FIGS. 6-8 the questions are about whether the employee is still taking certain medications. The questions which populate the question field are customized for each employee's individual health situation. For example, the asthma program would not be suggested to an employee who does not have asthma and the weight loss program would not be suggested to a person who is of normal weight. The questions are selected by the system itself based on analysis of the individual employee's profile according to preprogrammed algorithms, not by the health advocate professional.

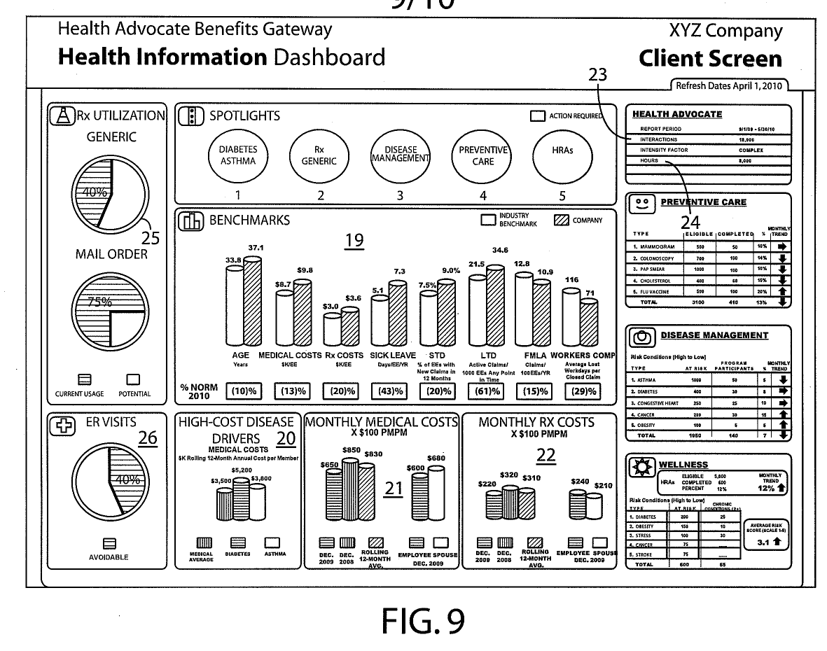

FIG. 9 illustrates an embodiment of a plan sponsor dashboard which summarizes employee medical benefit and prescription benefit information as well as productivity information such as benchmarks 19, high-cost disease drivers 20, monthly medical costs 21, monthly prescription costs 22, number of calls 23 and hours spent 24 with health advocate professionals, percentage of generic utilization 25, emergency room visits 26, and other data and analysis relative to the plan sponsor.

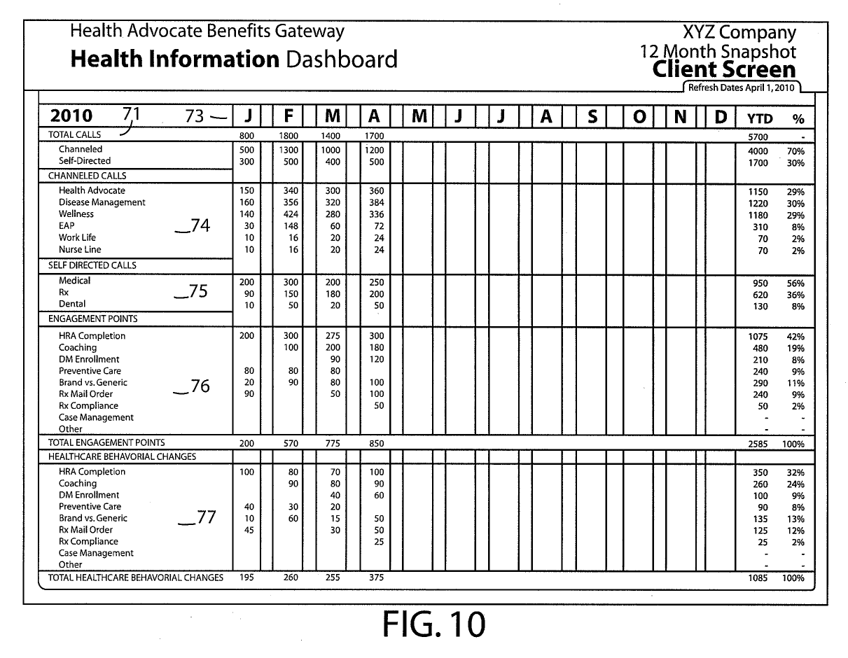

FIG. 10 illustrates a plan sponsor health information dashboard wherein summary information relating to employee population 72, medical benefits usage 70, preventive care activity 69, workers compensation 67, and key savings factors 66 are reported.

FIG. 11 illustrates a plan sponsor dashboard providing summary information 71 including total calls and subdivided among calls relating to various subgroups, 74, 75, 76, 77, and reporting on a month by month basis 73.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A method for assisting a health advocate professional in counseling employees of a plan sponsor comprising
receiving health records of employees of a plan sponsor;
analyzing data in the records;
displaying the analyzed data for any selected employee in dashboard format;
calculating any health improvement options for the selected employee; and
displaying the health improvement options in the form of questions to be asked by a health advocate professional viewing the displayed dashboard.

2. The method of claim 1 further comprising displaying a set of categories in spotlight format and a customized question to be asked relating to one of the categories when the corresponding spotlight is selected.

3. The method of claim 1 further comprising analyzing the health history and profile of a selected employee and displaying a set of categories in spotlight format and a customized question relating to one of the categories when the corresponding spotlight is selected, wherein the categories displayed fit the selected health history and profile of the selected employee based on a set of preprogrammed criteria.

4. The method of claim 1 further comprising displaying at least one spotlight button within the dashboard for a category selected from the group consisting of disease management, lifestyle coaching, prescription compliance, and medical test which, when clicked on or selected by the health advocate professional, automatically displays a question and a field for the health advocate professional to enter an answer, and record any answers in the record of the employee.

5. The method of claim 1 further comprising
receiving data from a human resource management system of the plan sponsor;
receiving data from a health care provider for employees of the plan sponsor;
receiving data from a health benefit vendor; and
updating the records as the data is received.

6. The method of claim 1 further comprising generating a plan sponsor interface which displays in dashboard format summaries of medical benefit usage by employees, risk factors, health insurance eligibility and usage, and contacts with a benefits provider.

7. The method of claim 1 wherein the health advocate professional dashboard displays data comprising an employee's name and one or more of the employee's medical plan, medical plan deductibles, amount of medical plan deductible met, medical plan co-pays, pharmacy plan, pharmacy plan deductibles, amount of pharmacy plan deductible met, pharmacy co-pays, smoking, weight, blood pressure, cholesterol, diabetes, asthma, high stress, sedentary behavior, heart disease risks, and program participation.

8. A computer system for assisting a health advocate professional in counseling employees of a plan sponsor comprising
a module adapted to receive a plurality of data feeds relating to records of employees of a plan sponsor from sources comprising the plan sponsor's human resources management system, and one or more health benefit vendors and store the records;
a module adapted to display a selected record in dashboard format; and
a module adapted to calculate any health improvement options in the form of questions to be asked by the health advocate professional viewing the displayed dashboard for the selected employee.

9. The computer system of claim 8 further comprising
a module adapted to generate a plan sponsor interface for presenting aggregated statistics calculated from the data feeds relating to employee benefits, medical benefit usage by employees, risk factors, health insurance eligibility and usage, and contacts with a benefits provider; and
the system adapted to display the plan sponsor interface to a plan sponsor representative and to display the personal health advocate interface to the personal health advocate in dashboard format and to receive data from a personal health advocate interacting with the dashboard display.

10. The computer system of claim 8 further comprising
a module adapted to analyze the data and to calculate appropriate risk area information and recommended intervention program information and display the risk area information and intervention program information in the employee interface; and
a module adapted to generate the summary risk area information and the summary recommended intervention program information in the plan sponsor interface.

11. The computer system of claim 8 further comprising
a module adapted to plan sponsor to calculate return on investment based on improvements in one or more of absenteeism, pharmacy benefit usage, wellness, and disease management.

12. The computer system of claim 8 further including: a health care provider user interface for receiving information about an employee of the plan sponsor pertinent to a prevention plan for the employee.

13. The computer system of claim 8 wherein the plan sponsor display includes current and historical plan sponsor insurance cost information calculated from the data.

14. The computer system of claim 8 wherein a set of categories customized to fit the health profile of an individual employee is displayed in spotlight format, questions customized to fit the profile are displayed when any of the spotlights is selected, and a field for answers to the questions to be entered by the health advocate professional is displayed.

15. A computer-assisted method for tracking employee health care-related costs and employee health care effectiveness of a plan sponsor having a population of employees comprising:
receiving a plurality of data feeds from sources comprising a plan sponsor human resources management system, one or more health care providers, and an employee self-reporting computer system;
calculating statistical information from the data; and
generating a plan sponsor dashboard interface for presenting the statistical information relating to employee benefits, medical benefits usage by employees, risk factors, health insurance eligibility and usage, and contacts with a benefits provider.

16. The computer-assisted method of claim 15 comprising
generating a personal health advocate dashboard interface for presenting individual-specific statistics calculated from the data relating to employee benefits, medical coverage, and risk factors;
displaying the plan sponsor dashboard interface to a plan sponsor representative and displaying the personal health advocate dashboard interface to the personal health advocate;
receiving data from a personal health advocate interacting with the dashboard display;
calculating levels of risk and need for intervention from the data; and
generating a prevention plan based on the levels of risk and need for intervention for display on the health care advocate dashboard interface or plan sponsor dashboard interface.

17. The method of claim 15 wherein the plan sponsor dashboard interface comprises one or more of employee statistics, return on investment factors, long term disability participant information, preventative care statistics, disease management statistics, wellness statistics, prescription statistics, medical benefits statistics, employee demographics, and productivity benchmarks.

18. The method of claim 15 wherein the health care advocate dashboard interface comprises employee-specific data comprising one or more of general information, medical coverage, prescription coverage and usage, dental plan, and risk areas.

19. The method of claim 15 further including generating a health care provider dashboard interface for receiving information about an employee of the plan sponsor pertinent to a prevention plan for the employee.

20. The method of claim 15 further including calculating current and historical plan sponsor insurance cost information from the data.

21. The method of claim 15 wherein the health benefits vendors are selected from employee assistance programs, disease management vendors, long term disability vendors, wellness vendors and the health care insurers are insurance companies.
